(19) United States
(12) Patent Application Publication
(10) Pub. No.: US 2023/0150801 A1
(43) Pub. Date: May 18, 2023

(54) ROPE SWINGING SAFETY SYSTEM

(71) Applicant: ELFATEK ELEKTRONIK MAKINA VE OTOMASYONU SANAYI TICARET LIMITED SIRKETI, Konya (TR)

(72) Inventor: Bahattin DUZGUN, Konya (TR)

(73) Assignee: ELFATEK ELEKTRONIK MAKINA VE OTOMASYONU SANAYI TICARET LIMITED SIRKETI, Konya (TR)

(21) Appl. No.: 17/583,862

(22) Filed: Jan. 25, 2022

(30) Foreign Application Priority Data
Nov. 17, 2021 (TR) 2021/017876

(51) Int. Cl. B66C 13/06

(52) U.S. Cl. CPC B66C 13/063

(57) ABSTRACT

A rope swinging safety system that aims to eliminate the safety risks caused by a rope swinging process in rope cranes, automatically calculates the amount of swinging depending on the angle of the rope or the diameter of the safe working area, allows parameter adjustment manually or by a remote controller, prevents erroneous adjustments, prevents lifting process when a determined swinging limit is reached so that it can be adapted to different situations easily, and is capable of electronically transmitting to the remote controller, a device and a remote controller consist of the system.

### FIELD AND BACKGROUND OF THE INVENTION

### Field of the Invention

The present invention relates to a rope swinging safety system, which aims to eliminate the safety risks caused by a rope swinging process in rope cranes and prevents a lifting process when a determined swinging limit is reached, and in which an amount of swinging can be adjusted automatically, manually or by means of a remote controller, thus easily adapting to different situations, wherein the safety system is capable of informing a user by a visual warning, as well as electronically transmitting whether the limit is exceeded or not.

### Background of the Invention

There are various safety systems for the safe operation of cranes available in the market. The most important of these are weight sensors. By means of these sensors, the load is tried to be prevented from being lifted beyond the crane capacity; however, these structures calculate the vertical effects of the load. Especially on rope cranes, however, the loads caused by the swinging of the rope affect the system in a different manner from the values predicted in the vertical weight sensor data. Despite working with loads below the lifting limit, these effects may cause the drum to break, the rope or hook to be damaged, and accidents that may put the safety of life and property at risk. Therefore, it is of great importance to keep the effect of dynamic loads arising from a swinging process under controller. In order to achieve this, solutions such as reducing the speed of lifting and horizontal transport movements, and balancing the dynamic loads by creating much heavier and costly structures are recommended in the current solution.

Some limiters are provided in crane systems to keep a rope angle at a certain value. It is often not possible to easily change their limit values. Therefore, the lifting speeds determined at the heaviest load in the initial design of the system generally have to be applied to lower loads, leading to significant efficiency losses.

In order for lower weight loads to be carried at higher speeds, the rope swinging limits need to be adjusted, which requires changing the rope angle measuring devices in the prior art or re-adjusting such devices, if possible, by physically reaching them. In this case, it causes significant losses in terms of time, labour and productivity. In addition, it creates security risks due to the possibility of inputting incorrect swinging values by the user. The swinging process is usually limited to angle values only in the x and y axis, which causes computational difficulties. In the current solutions, according to the devices for limiting back and forth and left and right movements, not only the adjustment difficulties are experienced, but also, for example, 3 cm of movement in the x-axis and 4 cm of movement in the y-axis can be allowed, which means 5 cm of swinging is allowed in the hypotenuse of the x and y axis. A standard user can often ignore this. Moreover, since ignoring these details makes it difficult to make both safe and precise adjustments, the capacity is generally cannot be fully used as the safety is put in the foreground. Also, insufficient use of capacity leads to ineffectiveness. Thus, there is a need for a user-friendly system not allowing a user to input an incorrect value so that the risks arising from incorrect adjustments are eliminated, which provides for an uncomplicated adjustment process such that only one increment and one decrement button are provided to make an adjustment, and adjustments are made valid for all circular swinging directions.

In addition to all these technical disadvantages, in order to determine the rope angle correctly in the current technique, the measuring device must be mounted in a region close to the highest point of the fixed end of the rope. This complicates accessing the device when adjustments are required. For that reason, alternative wired and wireless access facilities providing access to the device are needed.

Another technical disadvantage is having a lot of sensors that limit operation of the crane, in which case it is important for the user to know which or which of them has stopped working safely. For example, if an overload warning is given in case of an excessive weight, the user can understand that the load cannot be lifted safely, and reduce the load. Likewise, if the load is prevented from being lifted due to the rope swinging value, this also needs to be notified to the user by means of a visual warning.

In order to eliminate these disadvantages, there is a need for a remote-controlled system in which the swinging value can be limited in terms of an angle or distance unit when necessary, and automatic swinging values are produced depending on the load such that the user is prevented from inputting an incorrect value.

### Advantages of the Invention

The rope swinging safety system, which is the subject of the invention, provides successful solutions to the technical problems mentioned above. The rope swinging safety system, which is the subject of the invention, is a product consisting of two basic parts, a device and a control. It enables that the rope swinging values of the crane are controlled, adjustment of the incorrect swinging values is not allowed, adjustment processes are uncomplicated, adjustments are made valid for all circular swinging directions, thus the swinging values are adjusted both automatically and manually depending on the load, the vertical and horizontal movement speeds are increased and decreased in a safe manner so that the efficiency is improved, the swinging value is calculated and limited automatically by using the angular or operation area radius and height distance when necessary, the user is notified by means of visual warnings whether the limit values have been reached or not, and the adjustments and notification of reaching the limit can be made with the remote controller.

### BRIEF DESCRIPTION OF THE FIGURES

FIG. 1 is a perspective view of the elements constituting the rope swinging safety system.

FIG. 2 is a front perspective view of the device of the rope swinging safety system.

FIG. 3 is a rear perspective view of the device of the rope swinging safety system FIG. 4 is a perspective view of the rope swinging safety system device, applied on the rope of the crane.

FIG. 5 is a perspective view of the remote controller of the rope swinging safety system device

FIG. 6 is a detailed perspective view of the upper body of the rope swinging safety system device.

FIG. 7 is a detailed perspective view of the electronic circuit of the rope swinging safety system device.

FIG. 8 is a detailed perspective view of the lower body of the rope swinging safety system device.

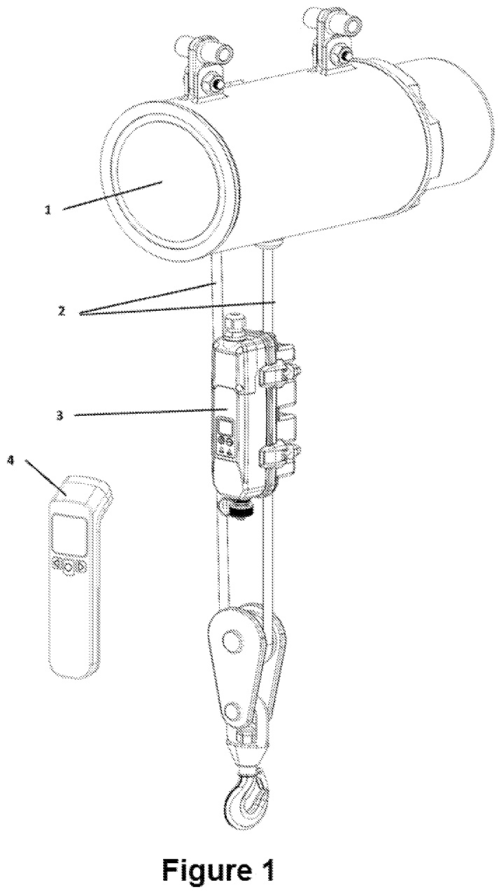

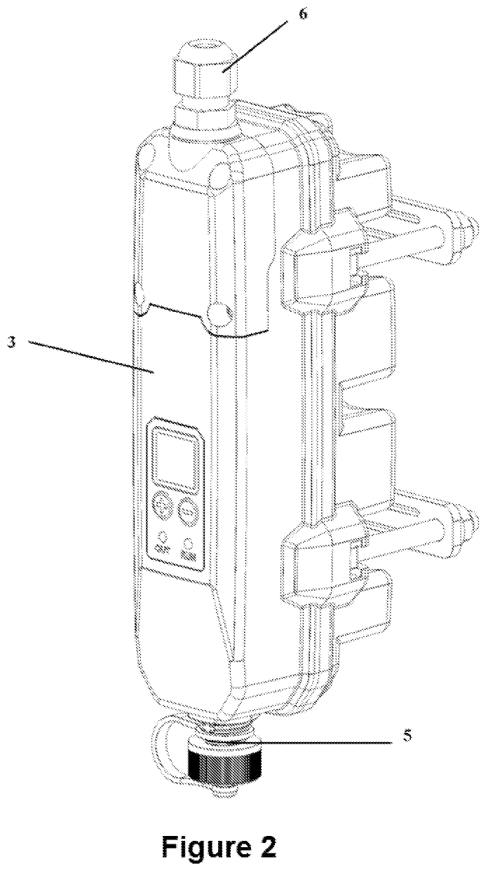

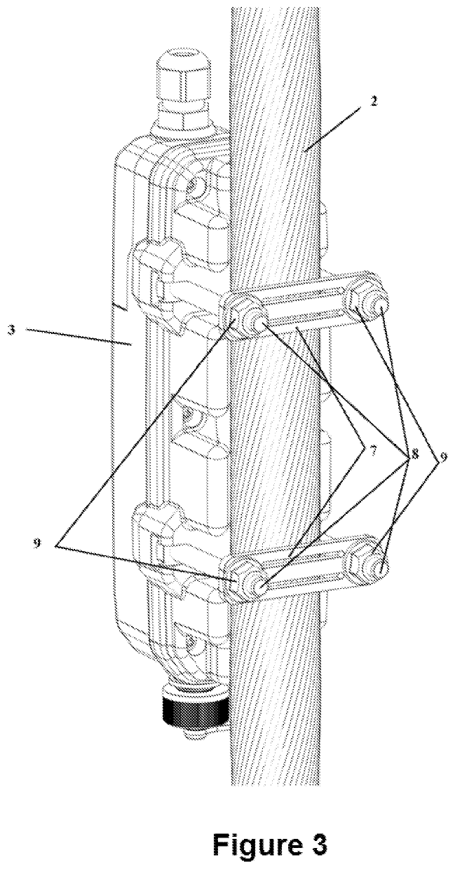

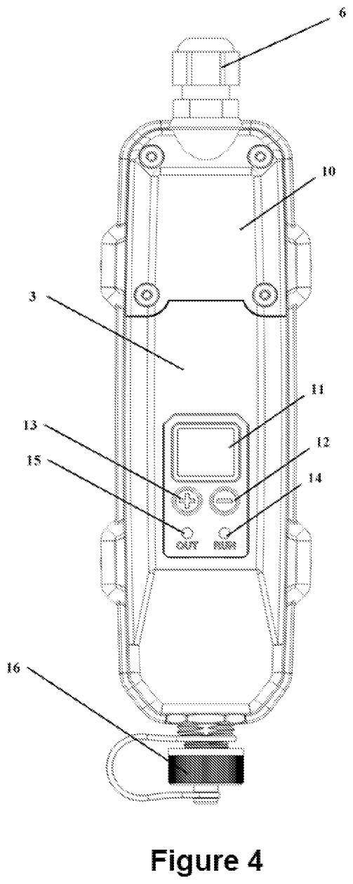

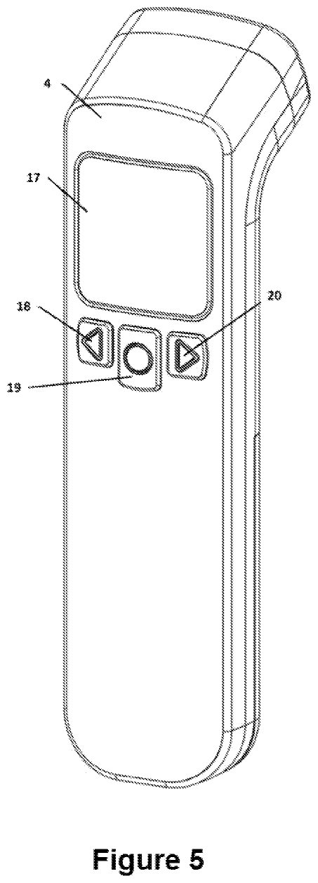

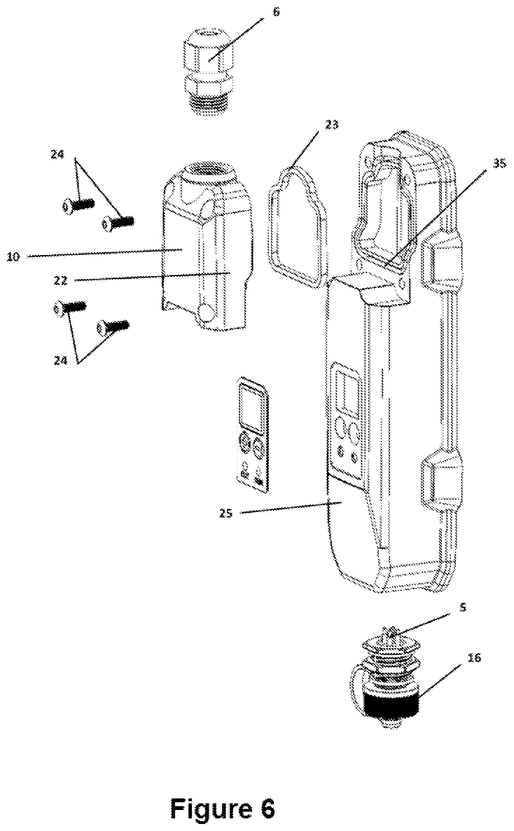

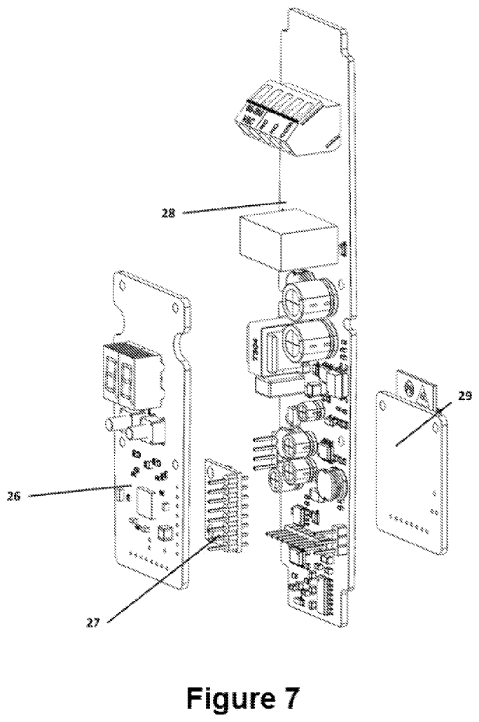

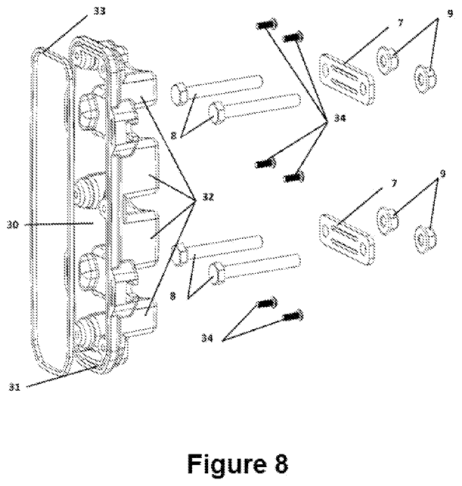

### EXPLANATION OF REFERENCES IN FIGURES

1: Rope drum of the crane
2: Rope
3: Device
4: Remote Controller
5: Cable communication connector
6: Connecting cable input
7: Rope gripper
8: Bolt
9: Flanged nut
10: Warning light
11: Display
12: Decrement button
13: Increment button
14: Safe operation light
15: Safe stop light
16: Protective cover for connector
17: Display for controller
18: Decrement button for controller
19: Confirmation button for controller
20: Increment button for controller
21: Decrement button for controller
22: Upper connection cover for cable
23: Upper connection cover gasket for cable
24: Upper connection cover screw for cable
25: Upper body
26: Control board
27: Sensor board
28: Power board
29: Communication circuit
30: Lower body
31: Gasket groove for lower body
32: Rope support for lower body
33: Joint gasket for body
34: Connecting screw for body
35: Gasket groove for upper body

### DETAILED DESCRIPTION OF THE INVENTION

According to the rope swinging safety system, the rope drum of the crane (1) is fixed in the highest possible fixed end of the rope (2) between a sufficient number of rope supports for lower body (32), which are located on the rear part of the lower body (30) of the device (3), by means of a sufficient number of rope grabbers (7), bolts (8) and flanged nuts (9). The rope support for lower body (32) is in even numbers, each pair positioned perpendicular to each other. Thus, the system can easily adapt to ropes of different thicknesses. Thanks to the positioning in the highest possible fixed end of the rope (2), a vertical view for the designed lifting height is achieved and it is possible to detect the swinging of the rope (2) more accurately.

According to the rope swinging safety system, a display (11), a decrement button (12) and an increment button (13), which all have a suitable size, are provided on the device (3). Rope swinging value can be decreased by the decrement button (12) and increased by the increment button (13), in terms of angle and/or distance, and the changed values can be displayed on the display (11). In this way, adjustment can be made manually.

According to the rope swinging safety system, a safe operation light (14) and a safe stop light (15), which all have a suitable size, are provided on the device (3). If the system operates within the adjusted limits, the safe operation light (14) informs the user that the swinging limit is not exceeded and the system is operating correctly. If the limit is exceeded, the lifting operation is not allowed and the safety stop light (15) and the warning light (10) inform the user that the swinging limit has been exceeded, so the lifting cannot be performed.

According to the rope swinging safety system, a cable communication connector (5) and a connecting cable entry (6) are also provided on the device (3). In this way, a connection to the system is provided by cables, and limit values can be adjusted and controlled. In this case, whether the limit value is exceeded or not is transmitted to the wired controller of the crane, and visual warnings are provided.

According to the rope swinging safety system, a protective cover for connector (16) is provided on the device (3), wherein the connector is prevented from being damaged by external environmental conditions when communication with cable is not provided.

According to the rope swinging safety system, the device (3) comprises a joint gasket for body (33) located between the upper body (25) and the lower body (30). The coupling gasket for body (33) is positioned in the gasket groove for lower body (31) which is located on the lower body (30), so that it protects the coupling of the upper body (25) and the lower body (30) from the negative effects of outdoor conditions. The lower body (30) and the upper body (25) are connected to each other by means of a sufficient number of connecting screws for body (34).

Since the upper connection cover gasket for cable (23) located between the upper body (25) and the upper connection cover for cable (22) is positioned in the gasket groove for upper body (35) provided in the upper part of the upper body (25), the junction point can be protected from the negative effects of outdoor conditions. The upper connection cover for cable (22) is connected to the upper body (25) by means of a sufficient number of upper connection cover screws for cable (24).

The upper connection cover for cable (22) is made of a transparent material which is completely light-transparent or only the front surface of which is light-transparent. In this way, it is possible to warn the user from a suitable distance via the warning light (10). While the device (3) is operating safely, the safe working light (14) and the warning light (10) are lighted in green. If the device (3) does not allow the lifting operation due to exceeding the limit values, the safety stop light (15) and the warning light (10) are lighted in red. Therefore, according to the colour of the warning light (10), the user can detect from a suitable distance whether the limit values are exceeded, so that he can take precautions.

The rope swinging safety system, the device (3) has at least one power board (28) for supplying energy from different power sources; at least one communication board (29) for making adjustments by connecting to the system via both wired and wireless communication; at least one sensor board (27) for measuring the swinging of rope in type of angle; and at least one control board (26) which calculates the safe working area and angle values and comprises user buttons and indicators for parameter settings in order to record the limit values, to record the measured values, to compare the measured values with the limit values, and to prevent an incorrect input by the user.

In the rope swinging safety system, the remote controller (4) provides a wireless access to the device (3). A display for controller (17), a decrement button for controller (18), a confirmation button for controller (19) and an increment button for controller (20), which all have a suitable size, are provided on the controller (4). Limit values and whether the limit values are exceeded or not are provided to the user over the display for controller (17).

When the setting of the limit values is desired, the angle or distance can be decreased with the control value decrease button (18) and increased with the control value increase button (20), and the appropriate value can be confirmed and recorded with the control confirmation button (19). In case of exceeding the limit values, the user is warned and measures are taken easily.

### INDUSTRIAL APPLICATION OF THE INVENTION

The rope swinging safety system, which brings successful solutions to the technical problems mentioned above, is a product that can be produced like other crane safety parts.

What is claimed is:

1. A rope swinging safety system, comprising:
a device (3) adapted to control safety risks arising from oscillation of a rope (2), wherein oscillation values of the rope (2) are determined as an angle or a diameter of a safe working area and a length of the rope (2), and are to be changed automatically and manually when necessary; and
at least a remote control (4) providing wireless access to the device (3).

2. The rope swinging safety system according to claim 1, wherein the device (3) has a display (11) of suitable size for displaying operational state and parameter settings; and a decrement button (12) and an increment button (13) for changing parameters manually.

3. The rope swinging safety system according to claim 1, wherein the device (3) has at least one safe working light (14) of suitable size, which informs the user visually that a safe operation is provided without exceeding the rope swinging limit;
at least one safe stop light (15) of suitable size, which informs the user visually that lifting is not allowed because the rope swinging limit has been exceeded; and
a warning light (10) of suitable size, which operates in synchronization with these lights.

4. The rope swinging safety system according to claim 1, wherein the device (3) comprises a sufficient number of rope grabbers (7), bolts (8) and flanged nuts (9) for connection with the rope (2).

5. The rope swinging safety system according to claim 1, wherein the device (3) comprises, at an inner part thereof, at least one power board (28) for supplying energy from different power sources;
at least one communication circuit (29) for making adjustments by connecting to the system via both wired and wireless communication;
at least one sensor board (27) in which a sufficient number of sensors are provided for measuring an angle of rope swing in all directions circularly; and
at least one control board (26) which calculates the safe working area and angle values and comprises user buttons and indicators for parameter settings in order to record the limit values, to record the measured values, to compare the measured values with the limit values, and to prevent an incorrect input by the user.

6. The rope swinging safety system according to claim 1, wherein the device (3) has a cable communication connector (5) which provides communication by connecting with a cable.

7. The rope swinging safety system according to claim 6, wherein the cable communication connector (5) has a protective cover for connector (16) for preventing the connector from being damaged by the outer environment conditions.

8. The rope swinging safety system according to claim 1, wherein the device (3) has upper body (25), lower body (30), cable upper connection cover (22), connection cables entry (6) and a sufficient number of lower body rope supports (32) on its outer part.

9. The rope swinging safety system according to claim 8, wherein the lower body rope support (32) is in pairs so that it can easily adapt to the ropes (2) of different thicknesses and each pair is in a perpendicular position to each other.

10. The rope swinging safety system according to claim 8, wherein the lower body (8) has a gasket groove for lower body (31).

11. The rope swinging safety system according to claim 8, wherein a joint gasket for body (33) is provided in the gasket groove for lower body (31) between the upper body (25) and the lower body (30), which provides protection for junction point against negative effects of outdoor conditions.

12. The rope swinging safety system according to claim 8, wherein the upper body (25) has a gasket groove for upper body (35).

13. The rope swinging safety system according to claim 8, wherein an upper connection cover gasket for (23) cable is provided in the gasket groove for upper body (35) between the upper body (25) and the upper connection cover for cable (22), and which provides protection for junction point against negative effects of outdoor conditions.

14. The rope swinging safety system according to claim 8, further comprising a sufficient number of connecting screws for body (33) allowing the lower body (30) and the upper body (25) to be connected to each other.

15. The rope swinging safety system according to claim 8, further comprising a sufficient number of upper connection cover screw for cable (24) allowing the upper body (25) and the upper connection cover for cable (22) to be connected to each other.

16. The rope swinging safety system according to claim 8, wherein the upper connection cover for cable (22) is made of a transparent material which is light-transparent.

17. The rope swinging safety system according to claim 1, wherein the remote controller (4) has a display for remote controller (17) of a suitable size, which displays the limit values and whether the limit values have been exceeded or not;
a decrement button for remote controller (18) which allows the swinging limit values to be decreased remotely, when desired, in terms of distance or angle;
a confirmation button for remote controller (19) for remotely recording the adjusted value; and
an increment button for remote controller (20) which allows the swinging limit values to be increased remotely, when desired, in terms of distance or angle.
